(19) United States
(12) Patent Application Publication
(10) Pub. No.: US 2007/0264183 A1
(43) Pub. Date: Nov. 15, 2007

(54) OIL-BEARING SANDS AND SHALES AND THEIR MIXTURES AS STARTING SUBSTANCES FOR BINDING OR DECOMPOSING CARBON DIOXIDE AND NOX, AND FOR PREPARING CRYSTALLINE SILICON AND HYDROGEN GAS, AND FOR PRODUCING NITRIDE, SILICON CARBIDE, AND SILANES

(75) Inventor: Florian Krass, Weggis (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SINCONO AG, Zug (CH)

(21) Appl. No.: 11/746,608

(22) Filed: May 9, 2007

(30) Foreign Application Priority Data
May 10, 2006 (DE) DE102006021960.0
Oct. 29, 2006 (EP) EP06022578.6

(51) Int. Cl. C01B 31/36

(52) U.S. Cl. 423/345

(57) ABSTRACT

The crude oil reserves have a calculable time limit. Before, for example, the automobile industry, aviation, the weapons industry, and space travel change their combustion engines over to silanes, which are known to combust with the air nitrogen in a hot chamber and provide atomic hydrogen, a possibility must be found to reduce the high oil prices. The very large reserves of oilbearing sands and jails provide the requirement for this purpose. The hydrocarbons of the minerals are decomposed into hydrogen and hydrocarbon residues to provide primary energy.

### CROSS-REFERENCES TO RELATED APPLICATIONS

This application claims the priority of the application DE 10 2006 021 960.0 having the title “Ölhaltige Sande und Schiefer und ihre Gemische als Ausgangssubstanzen zur Darstellung von kristallinem Silizium und Wasserstoffgas sowie zur Herstellung von Siliziumnitrid, Siliziumcarbid und Silanen,” which was filed on 10 May 2006; and

This application further claims the priority of the application EP 06 022 578.6 having the title “Ölhaltige Sande und Schiefer und ihre Gemische als Ausgangssubstanzen zum Binden oder Zerlegen von Kohlenstoffdioxid und Nox, sowie zur Darstellung von kristallinem Silizium und Wasserstoffgas sowie zur Herstellung von Siliziunmitrid, Siliziumcarbid und Silanen”, which was filed on 29 Oct. 2006. Both applications are incorporated herein by reference in their entirety for all purposes.

### BACKGROUND OF THE INVENTION

Oil-bearing sands and shales and their mixtures as starting substances for binding or decomposing carbon dioxide and NOx, and for preparing crystalline silicon and hydrogen gas, and for producing silicon nitride, silicon carbide, and silanes

### BRIEF SUMMARY OF THE INVENTION

Carbon dioxide is a chemical compound comprising carbon and oxygen. Carbon dioxide is a colorless and odorless gas. At low concentration, it is a natural component of air and arises in living organisms during cell respiration, but also during the combustion of carbonaceous substances with sufficient oxygen. Since the beginning of industrialization, the CO₂ component in the atmosphere has significantly increased. The main reasons for this are the CO₂ emissions caused by humans—known as anthropogenic emissions.

The carbon dioxide in the atmosphere absorbs a part of the thermal radiation. This property makes carbon dioxide into a greenhouse gas and is one of the causes of the greenhouse effect.

In addition to this climate-relevant aspect, however, CO₂ also has a negative influence on health. If CO₂ is provided in a concentration in the blood of humans which lies above the physiological concentration (in the meaning of natural), it may result in reduction or even cancellation of the reflex respiratory impulse, for example. However, CO₂ may also result in headaches and dizziness, and at higher concentrations even in accelerated heart rate, elevated blood pressure, difficulty breathing, and loss of consciousness.

In addition, CO₂ changes the chronological biology of the plant world, which no longer runs synchronously. The stability of the food chain is thus endangered.

For these and also other reasons, research and development is currently being performed in greatly varying directions to find a way of reducing the anthropogenic CO₂ emissions. There is a great need for CO₂ reduction in particular in connection with energy production, which is frequently performed by the combustion of fossil energy carriers, such as coal or gas, but also in other combustion processes, for example, during garbage combustion. Hundreds of millions of tons of CO₂ are released into the atmosphere every year by such processes.

The fuels required for producing heat generate CO₂, as explained at the beginning. Up to this point, no one has arrived at the idea of using the sand provided in oil-bearing sands (SiO₂), oil-bearing shale (SiO₂+[CO₃]²), in bauxite, or tar-bearing sands or shales, and other mixtures to reduce the CO₂ discharge and, in addition, obtain new raw materials from the products of such a novel method.

Instead of using naturally occurring mixtures of sand and oil in this novel method, industrial or natural waste containing hydrocarbons, possibly after admixing with sand, may also be used.

Using natural asphalt (also referred to as mineral pitch) instead of the oil component is also conceivable. A mixture made of asphalt with pure sand or with construction rubble which contains a sand component is especially preferable.

However, water glass, a mixture of sand with acid or base, may also be used, the water glass being admixed with mineral oils in order to provide the hydrocarbon component necessary for the present invention (microemulsion method).

The reserves of oil-bearing sands (SiO₂) and shales (SiO₂+[CO₃]²) are known to exceed the world oil reserves multiple times over. The technical methods applied for separating oil and minerals are currently ineffective and too costly. Natural asphalt occurs at multiple locations of the earth, but is currently mined at commercial scale primarily in Trinidad.

Sand occurs in greater or lesser concentrations everywhere on the surface of the earth. A majority of the sand occurring comprises quartz (silicon dioxide; SiO₂).

The object of the present invention is to provide such possible raw materials and describe their technical production. The chemical findings used in the method are characterized in that the hydrocarbons present in the sand and shales and other mixtures participate in a reaction, and also the SiO₂ is chemically changed by the reaction.

1) Aluminum oxide (Al₂O₃) and silicon (Si) may be produced from the oil-bearing sands or the other cited mixtures by combustion together with liquid Aluminum or hot Aluminum dust. Strongly simplified, the following reaction occurs:

SiO₂+Al→Si+Al₂O₃

2) The mineral oil of the sands is pyrolyzed at high temperatures to form “illuminating gas”. This gas mixture is largely free of CO and CO₂, if a slight hydrogen excess is used during the combustion of the Aluminum, for example. The gas mixture thus predominantly comprises hydrogen, which originates from the carbon chains of the mineral oils. The carbon itself precipitates at suitable operating temperature as a residue similar to graphite and may be used as an anode, for example.

3) The heat released at the furnace in the thermal reaction of the main process may drive the turbine of a generator as strongly compressed water steam, for example.

4) The most important ceramics used in technology—silicon nitride (Si₃N₄: having a hardness similar to diamond) and silicon carbide (SiC: having its noteworthy thermal conductivity)—may be obtained in the same reaction start by other reaction conditions, as explained in numbers 5 through 7.

5) If needed, the crystalline silicon (e.g., as a powder at suitable temperature) may be reacted after ignition directly with pure (cold) nitrogen (e.g., nitrogen from the ambient air) to form silicon nitride, because the reaction is strongly exothermic. (Si₃N₄ is a solid noble gas [Plichta].) The heat thus arising may be used as described in number 3. One may for instance use a method for obtaining nitrogen which is known from making stainless steel using propane gas (propane nitration).

6) The carbonaceous residue resulting in number 2 may also be reacted exothermically with the crystalline silicon obtained to form silicon carbide.

7) The available crystalline silicon has surfactant properties and may be treated catalytically (e.g., using magnesium and/or Aluminum as a catalyst) with hydrogen, monosilane resulting. This monosilane may be removed from the reaction chamber and subjected once again at another location to a catalytic pressure reaction. According to the equation

Si+SiH₄→(Using catalysts such as Pt, etc.)→Si(SiH₄₄)+SiHₙ(SiH₄)ₘ+SiₙHₘ

long-chain silanes may be prepared, which may be used in the technology of fuel cells, in engines based on ceramic, and also in scram jet drives.

This is also suitable for the combustion of nitrogen with silanes.

Further details and advantages of the present invention are described in the following on the basis of exemplary embodiments.

### DETAILED DESCRIPTION OF THE INVENTION

In the following, the present invention is described on the basis of examples. A first example relates to the application of the present invention in a power plant operation, in order to reduce or even eliminate the CO₂ discharge arising therein while obtaining energy.

According to the present invention, there is an array of chemical reactions running in a targeted way, in which new chemical compounds (called products) result from the starting materials (also called educts or reactants). The reactions according to the present invention of the method identified at the beginning as the main process are designed in such a way that CO₂ is consumed and/or bound in significant quantities.

In a first exemplary embodiment, sand which is admixed with mineral oil or oil shales are used as starting materials, for example. These starting materials are supplied to a reaction chamber, for example, in the form of an afterburner or a combustion chamber. CO₂ is blown into this chamber. In the first exemplary embodiment, this CO₂ may be the CO₂ exhaust gas which arises in large quantities when obtaining energy from fossil combustibles and up to now has escaped into the atmosphere in many cases. In addition, (ambient) air is supplied to the chamber. Instead of the ambient air, or in addition to the ambient air, steam or hypercritical H₂O at over 407° C. may be supplied to the method.

Furthermore, nitrogen is to be blown in at another point in the method, or the combustion chamber, respectively.

In addition, a type of catalyst is used. Aluminum is especially suitable. Under suitable environmental conditions, a reduction occurs in the chamber, which may be represented greatly simplified as follows:

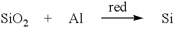

This means that the quartz component present in the sand or shale is converted into crystalline silicon.

The mineral oil of the sand used assumes the role of the primary energy supplier and is largely decomposed pyrolytically into hydrogen (H₂) and a compound similar to graphite at temperatures above 1000° C. in the method according to the present invention. The hydrogen is thus withdrawn from the hydrocarbon chain of the mineral oil in the running reactions. The hydrogen may be diverted into pipeline systems of the natural gas industry or stored in hydrogen tanks, for example.

In a second exemplary embodiment, the present invention is applied in connection with a pyrolysis method of Pyromex AG, Switzerland. The present invention may also be used as a supplement or alternative to the oxyfuel method. Thus, for example, using the present invention, heat may be obtained by an energy cascade according to the following approach. In an alteration of the oxyfuel method, additional heat is generated with the addition of Aluminum, preferably liquid Aluminum, and with combustion of oil sand (instead of oil or coal) with oxygen (O₂) and, if needed, also nitrogen (N₂) (Wacker accident). If the nitrogen coupling to silicon compounds is needed, the pure nitrogen atmosphere is preferably achieved from ambient air by combustion of the oxygen component of the air with propane gas (known from propane nitration).

According to the present invention, Aluminum (Al) may be used. It is currently only possible to obtain Aluminum cost-effectively from bauxite. Bauxite contains approximately 60% Aluminum oxide (Al₂O₃), approximately 30% iron oxide (Fe₂O₃), silicon oxide (SiO₂), and water. This means the bauxite is typically always contaminated with the iron oxide (Fe₂O₃) and the silicon oxide (SiO₂).

Al₂O₃ cannot be chemically reduced because of its extremely high lattice energy. However, it is possible to produce Aluminum industrially by fused-salt electrolysis (cryolite-alumina method) of Aluminum oxide Al₂O₃. The Al₂O₃ is obtained by the Bayer method, for example. In the cryolite-alumina method, the Aluminum oxide is melted with cryolite (salt: Na₃[AlF₆]) and electrolyzed. In order not to have to work at the high melting temperatures of Aluminum oxide of 2000° C., the Aluminum oxide is dissolved in a melt of cryolite. Therefore, the operating temperature in the method is only from 940 to 980° C.

In fused-salt electrolysis, liquid Aluminum arises at the cathode and oxygen arises at the anode. Carbon blocks (graphite) are used as anodes. These anodes burn off due to the resulting oxygen and must be continuously renewed.

It is seen as a significant disadvantage of the cryolite-alumina method that it is very energy consuming because of the high binding energy of the Aluminum. The formation and emission of fluorine, which sometimes occurs, is problematic for the environment.

In the method according to the present invention, bauxite may be added to the method to achieve cooling of the process. The excess thermal energy in the system may be handled by the bauxite. This is performed analogously to the method in which scrap iron is supplied to an iron melt in a blast furnace for cooling when the iron melt becomes too hot.

Cryolite may be used as an aid if the method threatens to go out of control (see Wacker accident), in order to thus reduce the temperature in the system in the meaning of emergency cooling.

Like silicon carbide, silicon nitride is a wear resistant material which can be or is used in highly stressed parts in mechanical engineering, turbine construction, chemical apparatus, and engine construction.

Further details on the chemical proceedings and energy processes described may be inferred from the following pages

Quartz sand may be reacted with liquid Aluminum exothermically to form silicon and Aluminum oxide according to the Hollemann-Wiberg textbook:

3SiO₂+4 Al (l)→3Si+2 Al₂O₃ ΔH=−618.8 kJ/Mol (exothermic)

Silicon combusts with nitrogen to form silicon nitride at 1350° C. The reaction is again exothermic

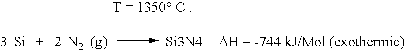

Silicon reacts slightly exothermically with carbon to form silicon carbide.

Si+C→SiC ΔH=−65.3 kJ/Mol (exothermic)

In addition, silicon carbide may be obtained endothermically directly from sand and carbon at approximately 2000° C.:

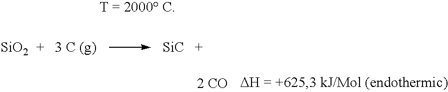

In order to reclaim Aluminum from the byproduct bauxite or Aluminum oxide Al₂O₃, liquid Al₂O₃ (melting point 2045° C.) is electrolyzed without adding cryolite to form Aluminum and oxygen. The reaction is strongly endothermic and is used for cooling the exothermic reactions.

2Al₂O₃(l)→4Al(l)+3O₂(g) ΔH=+1676,8 kJ/Mol (endothermic)

Production of the silanes:

Magnesium reacts with silicon to form magnesium silicide:

2 Mg+Si→Mg₂Si

Magnesium silicide reacts with hydrochloric acid to form monosilane SiH₄ and magnesium chloride:

Mg₂Si+4HCl(g)→SiH₄+2 MgCl₂

This synthetic pathway must actually also function with Aluminum: as a result, Aluminum silicide Al₄Si₃ arises as an intermediate product.

Higher silanes are possibly only accessible via polymerization of SiCl₂ with SiCl₄ and by subsequent reaction with LiAlH₄, as the preceding work documents.

Producing silicon carbide and silicon nitride from oil sand

### 1. INTRODUCTION AND “FORMULA” FOR OIL SAND

The ceramic materials silicon nitride Si₃N₄ and silicon carbide SiC may be obtained from an oil sand having approximately 30 wt.-percent petroleum via a multistage process. In order to be able to deal with the mixture of greatly varying hydrocarbon compounds known as petroleum, which is very chemically complex, in a stoichiometrically meaningful way, the formula C₁₀H₂₂, which actually stands for decane, is used in place of the petroleum. Sand, a material which is exactly described by the formula SiO₂, is in a weight ratio of 70% to 30% with the petroleum contained therein. The oil sand is thus described in a coarse approximation by the formula SiO₂+C₁₀H₂₂, SiO₂ contributing a molecular weight of 60 g/mole and decane contributing a molecular weight of 142 g/mole. If one takes 100 g oil sand, 70 g SiO₂ and 30 g “decane” or petroleum are provided. If the material quantities of SiO₂ and “decane” contained therein are worked out, one obtains for SiO₂:

n=(70 g)/(60 g/mole)≈1.167 mole SiO₂

And for petroleum:

n=(30 g)/(142 g/mole)≈0.211 mole C₁₀H₂₂

If both mole numbers are multiplied by 5, 1 obtains 5.833 mole for SiO₂ and 1.056 mole for C₁₀H₂₂, which makes about 6 mole SiO₂ for a mole of C₁₀H₂₂. Therefore, the formula 6 SiO₂+“1” C₁₀H₂₂ may be used in a good approximation for oil sand.

### 2. SYNTHETIC PATHWAY

The preparation of silicon nitride Si₃N₄ from oil sand is performed as follows: firstly, the oil sand is heated together with dichloromethane CH₂Cl₂ in an oxygen-free atmosphere to 1000° C. Silicon changes the bonding partner and forms of silicon tetrachloride according to equation (I):

6SiO₂+C₁₀H₂₂+12CH₂Cl₂→6SiCl₄+12 CO+10CH₄+3H₂ (I)

In a second step, the silicon chloride obtained is hydrogenated at room temperature with lithium Aluminum hydride [1], according to equation (II).

SiCl₄+LiAlH₄→SiH₄+LiAlCl₄ (II)

Finally, the monosilane SiH₄ obtained is combusted in pure nitrogen, equation (III):

3SiH₄+4N₂→Si₃N₄+4NH₃ (III)

In order to obtain silicon carbide SiC, instead of the high temperature reaction (equation IV), which occurs at 2000° C. and consumes a large amount of energy, a more energetically favorable reaction pathway may also be found.

SiO₂+3C→SiC+2CO (IV)

In this case, one again starts from silicon tetrachloride SiCl₄, which is obtained from equation (I), and reacts it with graphite or methane:

SiCl₄+CH₄→SiC+4HCl (V)

or:

SiCl₄+2C−>SiC+CCl₄ (VI)

### 3. STOICHIOMETRIC CALCULATIONS

If one starts with 1 kg oil sand, 700 g silicon dioxide and 300 g “decane” are contained therein. Converted into the material quantities, n=11.67 mole results for silicon dioxide and n=2.11 mole results for “decane”.

According to equation (I), the following relative molecular weights apply for the compounds:

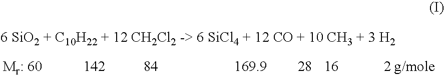

Since the material quantity for silicon tetrachloride SiCl₄ is the same because of the identical stoichiometric factor, a quantity of SiCl₄ results from 1 kg oil sand of:

m(SiCl₄)=11.67 mole*169.9 g/mole=1.982 kg SiCl₄

Because of the double material quantity of CO in relation to SiO₂, a mass of CO results as follows:

m(CO)=2*11.67 mole*28 g/mole=653 g CO

Because of the tenfold material quantity of CH₄ in relation to “decane”, a mass of CH₄ results as follows:

m(CO)=10*2.11 mole*16 g/mole=338 g CH₄

Because of the halved material quantity of H₂ in relation to SiO₂, a mass of H₂ results as follows:

m(CO)=½*11.67 mole*2 g/mole=11.67 g H₂

Furthermore, since all stoichiometric factors are equal to one in equation (II):

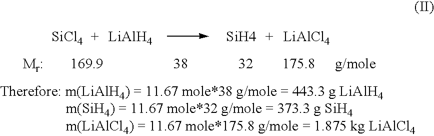

Since, in equation (III) the initial material quantity of silicon dioxide of 11.67 mole is still present, and the material quantity of Si3N₄ is a third that of SiH₄, in this case:

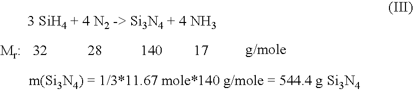

The material quantity of N₂ is 4/3 that of SiH₄: a mass of nitrogen may thus be calculated of:

m(N₂)= 4/3*11.67 mole*28 g/mole=435.5 g N₂

Converted to volume, these 435.5 g N₂ correspond, at a molar volume of 22.41, to: V=348.41 N₂.

The material quantity of NH₃ is also 4/3 that of SiH₄:

m(NH₃)= 4/3*11.67 mole*17 g/mole=264.4 g NH₃

Converted to volume, these 435.5 g NH₃ again correspond, at a molar volume of 22.41, to: V=348.41 NH₃.

Finally, the initial material quantity of 11.67 mole again applies for silicon tetrachloride for equation (V):

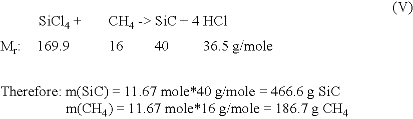

Converted to volume, these 186.7 g CH₄ correspond, at a molar volume of 22.4 1, to: V=261.3 1 CH₄.

m(HCl)=4*11.67 mole*36.5 g/mole=1.703 kg HCl

When calculated in the scale of tons, the units g may be replaced by kg, kg by tons t, and liters by m³, without anything changing in the numeric values.

### 4. THERMODYNAMIC CALCULATIONS

The data for calculating the reaction enthalpy or heat tonality ΔH and the Gibbs free enthalpy ΔG originate from the standard work by Landolt and Börnstein [2]. Hess's law applies for calculating ΔH from the standard formation enthalpy Δh° of the individual compounds:

ΔH=ΣnᵢΔh°i (products)−ΣmᵢΔh°i(educts)

nᵢ, mi representing the relevant stoichiometric factors.

### If a value for ΔH<0 results, it is an exothermic reaction.

### If a value for ΔH>0 results, it is an endothermic reaction.

Entirely analogously, to calculate the entropy change ΔS and the heat capacity change ΔCₚ:

ΔS=ΣnᵢΔS°i(products)−ΣmᵢΔS°i(educts)

ΔCₚ=ΣnᵢΔCₚᵢ(products)−ΣmᵢΔCₚᵢ(educts)

S°ᵢ representing the standard entropy at room temperature (T=298 K) of the compound i.

### If a value of ΔS<0 results, there is an entropy reduction.

### If a value of ΔS>0 results, there is an entropy increase.

If the enthalpy change is not sought at the standard temperature T of 298 Kelvin, but rather at another temperature, Kirchhoff's law applies under the aspect of the isobaric condition:

$$Δ H ( {T}_{2} ) = Δ H ( {T}_{1} ) + {\int }_{{T}_{2}}^{{T}_{1}} Δ {C}_{p} ( T ) d T \approx Δ H ( {T}_{1} ) + Δ {C}_{p} ( T ) ( {T}_{2} - {T}_{1} )$$

ΔCp representing the molar change of the heat capacity at constant pressure. If the entropy change is not sought at the standard temperature T of 298 Kelvin, but rather at another temperature, Kirchhoff's law applies analogously under the aspect of the isobaric condition:

$$Δ S ( {T}_{2} ) = Δ S ( {T}_{1} ) + {\int }_{{T}_{1}}^{{T}_{2}} Δ {C}_{p} ( T ) d T \approx Δ S ( {T}_{1} ) + Δ {C}_{p} ( T ) ln ( {T}_{2} / {T}_{1} )$$

The free Gibbs enthalpy G indicates in what regard a reaction runs spontaneously or non-spontaneously. The free enthalpy change ΔG is calculated by the formula:

ΔG=ΔH−T*ΔS

If a value for ΔG<0 results, a spontaneous, i.e., exergonic reaction exists.

If a value for ΔG>0 results, a nonspontaneous, i.e., endothermic reaction exists.

The following thermodynamic variables apply for equation (I):

6SiO₂+C₁₀H₂₂+12CH₂Cl₂−>6SiCl₄+12CO+10CH₄+3H₂ (I)

| | SiO₂ | C₁₀H₂₂(g) | CH₂C₁₂(g) | SiCl₄(g) | CO(g) | CH₄(g) | H₂(g) |
|---|---|---|---|---|---|---|---|
| Δh° | −859.3 | −249.7(g) | −117.1 | −577.4 | −110.5 | −74.85 | 0 |
| kJ/mol | | | | | | | |
| S° J/mol | 42.09 | 540.05(g) | 270.2 | 331.4(g) | 197.4 | 186.19 | 130.6 |
| Kelvin | | | | | | | |
| Cₚ J/mol | 44.43 | 243.1(g) | 51.1 | 90.58(g) | 29.15 | 35.79 | 28.83 |
| Kelvin | | | | | | | |

### The value is calculated as follows for ΔH:

ΔH=6*(−577.4)+12*(−110.5)+10*(−74.85)−6*(−859.3)−(−249.7)−12*(−117.1) kJ/mol,

ΔH=+1271.8 kJ/mol

### Equation (I) is thus a reaction running endothermically at room temperature, since ΔH>0.

The following value is obtained for ΔS:

ΔS=6*331.4+12*197.4+10*186.19+3*130.6−6*42.09−540.5−12*270.2 J/mol Kelvin

ΔS=+2575.46 J/mol Kelvin

The entropy is increased, thus equation (I), at least favored by the driving force of entropy, will probably react toward the product side. In order to definitively answer this question, the free enthalpy change ΔG must still be calculated, the following formula being used

ΔG=ΔH−T*ΔS

The standardized 298 Kelvin is used for the temperature T. Therefore, ΔG=+1271.8 kJ/mole−298 K*2575.46 J/mole K=+504.31 kJ/mole. At room temperature, the free enthalpy change ΔG is positive, which indicates that the reaction (I) runs endergonically or non-spontaneously at this temperature. The driving force of the entropy is thus insufficient in the final analysis to displace the reaction toward the product side, since the endothermic contribution of the heat tonality counteracts it too strongly.

But what effect does a temperature increase have on ΔH, ΔS, and ΔG? For this purpose, ΔH (T=1300 K) and ΔS (T=1300 k) are calculated via the change of the heat capacity ΔCp in isobaric conditions.

ΔCₚ=6*90.58+12*29.15+10*35.79+3*20.83−6*44.43−243.1−12*51.1 J/mole Kelvin,

ΔCₚ=+214.79 J/mole Kelvin

ΔH(T=1300 K)=ΔH(T=298 K)+ΔCₚ(1300 K−298 K)=+1271.8 kJ/mole+214.79

J/mole*K*1002 Kelvin=+1487 kJ/mole, the reaction remains endothermic.

ΔS(T=1300 K)=ΔS(T=298 K)+ΔCₚ*ln (1300 K/298 K)=+2575.46 J/mole K+214.79

J/mole*K*ln(4.3624)=+2891.85 J/mole*K

ΔG(1300 K)=ΔH(1300 K)−T*ΔS (1300 K)=+1487 kJ/mole−1300 K*2891.85 J/mole*K

ΔG(1300 K)=−2272.41 kJ/mole, the reaction suddenly becomes exergonic at 1300 K.

The reaction may thus occur at 1300 Kelvin.

The following thermodynamic variables apply for equation (II):

SiCl₄+LiAlH₄−>SiH₄+LiAlCl₄

| | SiCl₄ | LiAlH₄ | SiH₄ | LiAlCl₄ |
|---|---|---|---|---|
| Δh° | −577.4 | −100.8 | −61.0 | −1114.15 |
| kJ/mol | | | | |
| S° J/mol | 331.4 (g) | ? | 204.5 | 225.2 |
| Kelvin | | | | |

ΔH=(−61.0)+(−1114.15)−(−577.4)−(−100.8)kJ/mole=−496.95 kJ/mole

Equation (II) is thus an exothermic reaction, since ΔH<0.

For ΔS, the value of the entropy change may not be ascertained, since the entropy specified for LiAlH₄ was not found [2]. In contrast, this reaction is described in Lehrbuch der Anorganischen Chemie [Textbook of Inorganic Chemistry] by Hollemann-Wiberg [1] as running spontaneously or exergonically at room temperature, which indicates that it must be the case that ΔG<0.

The following thermodynamic variables apply for equation (III):

3SiH₄+₄N2−>Si₃N₄+4NH₃ (III)

| | SiH₄ | N₂ | Si₃N₄ | NH₃ |
|---|---|---|---|---|
| Δh° | −61.0 | 0 | −750.0 | −46.19 |
| kJ/mol | | | | |
| S° J/mol | 204.5 (g) | 191.5 | 95.4 | 192.5 |
| Kelvin | | | | |

ΔH=(−750.0)+4*(−46.19)−3*(−61.0)−0 kJ/mole=−751.76 kJ/mole

Equation (III) is thus an exothermic reaction, since ΔH<0.

The following value is obtained for ΔS:

ΔS=95.4+4*192.5−3*204.5−4*191.5 kJ/mole Kelvin

ΔS=−514.1 J/mole Kelvin, i.e., the reaction results in an entropy reduction.

With ΔG=ΔH−T*ΔS, the amount ΔG=−496.95 kJ/mole −298 K*(−514.1) J/mole K=−598.56 kJ/mole

Therefore, at room temperature, the free enthalpy ΔG is negative, which indicates that the reaction (III) runs exergonically, i.e., completely spontaneously, without external compulsions at this temperature. Nonetheless, an ignition temperature of approximately 900 K must be selected in order to set the reaction going merely because of the activation energy required for breaking the N₂ molecule. The reaction subsequently sustains itself on its own.

The following thermodynamic variables apply for equation (V):

SiCl₄+CH₄−>SiC+4HCl (V)

| | SiCl₄ | CH4 | SiC | HCl |
|---|---|---|---|---|
| Δh° | −577.4 | −74.85 | −111.7 | −92.31 |
| kJ/mol | | | | |
| S° J/mol | 331.4 | 186.19 | 16.46 | 186.9 |
| Kelvin | (g) | | | |
| Cp J/mol | 90.58 | 35.79 | 26.65 | 29.12 |
| Kelvin | (g) | | | |

ΔH=(−111.7)+4*(−92.31)−(−577.4)−(−74.85) kJ/mole=+171.31 kJ/mole

Equation (V) is thus a reaction which runs endothermically at room temperature, since ΔH>0.

The following value is obtained for ΔS:

ΔS=16.46+4*186.9−331.4−186.19 kJ/mole,

ΔS=+246.47 J/mole Kelvin, i.e., an entropy increase occurs!

With ΔG=ΔH−T*ΔS, the amount ΔG=+171.31 kJ/mole−298 K*246.47 J/mole K=+97.86 kJ/mole.

The reaction is thus both endothermic (ΔH>0) and also endergonic (ΔG>0) at room temperature. It may therefore not occur at room temperature.

ΔCₚ=26.65+4*29.12−90.58−35.79 J/mole Kelvin=+16.76 J/mole Kelvin

ΔH(T=1300 K)=ΔH(T=298 K)+ΔCₚ(1300 K−298 K)=+171.31 kJ/mole+16.76

J/mole*K*1002 Kelvin=+188.1 kJ/mole, the reaction remains endothermic.

ΔS(T=1300 K)=ΔS(T=298 K)+ΔCₚ*ln(1300 K/298 K)=+246.47 J/mole K+16.76

J/mole*K*ln(4.3624)=+271.16 J/mole*K

ΔG(1300 K)=ΔH(1300 K)−T*ΔS(1300 K)=+188.1 kJ/mole−1300 K*271.76 J/mole*K

ΔG(1300 K)=−164.4 kJ/mole, the reaction suddenly becomes slightly exergonic at 1300 K.

The reaction may thus occur at 1300 Kelvin.

The following thermodynamic variables apply for equation (VI):

SiCl₄+2C−>SiC+CCl₄ (VI)

| | SiCl₄ | C | SiC | CCl₄ |
|---|---|---|---|---|
| Δh° kJ/mol | −577.4 | 0 | −111.7 | 106.7 (g) |
| S° J/mol | 331.4 (g) | 5.74 | 16.46 | 309.7 (g) |
| Kelvin | | | | |
| Cp J/mol | 90.58 (g) | 8.53 | 26.65 | 83.4 (g) |
| Kelvin | | | | |

ΔH=(−111.7)+(−106.7)−(−577.4)−0 kJ/mole=+359.0 kJ/mole

Equation (VI) is thus a reaction which runs endothermically at room temperature, since ΔH>0.

The following value is obtained for ΔS:

ΔS=16.46+309.7−331.4−2*5.74 kJ/mole Kelvin

ΔS=−16.72 J/mole Kelvin, i.e., a slight entropy reduction occurs.

### With ΔG=ΔH−T*ΔS, the amount ΔG=+359.0 kJ/mole−298 K*(−16.72) J/mole K=+364.0 kJ/mole.

The reaction is thus both endothermic (ΔH>0) and also endergonic (ΔG>0) at room temperature. It may therefore not occur at room temperature. What about at a temperature of 1300 Kelvin?

The following value is obtained for ΔCₚ:

ΔCₚ=26.65+83.4−90.58−2*8.53 J/mole Kelvin=+2.41 J/mole Kelvin

ΔH(T=1300 K)=ΔH(T=298 K)+ΔCₚ(1300 K−298 K)=+359.0 kJ/mole+2.41

J/mole*K*1002 Kelvin=+361.4 kJ/mole, the reaction remains endothermic.

ΔS(T=1300 K)=ΔS(T=298 K)+ΔCₚ*ln(1300 K/298 K)=−16.72 J/mole K+2.41

J/mole*K*ln(4.3624)=−13.17 J/mole*K

ΔG(1300 K)=ΔH(1300 K)−T*ΔS(1300 K)=+361.4 kJ/mole−1300 K*(−13.17 J/mole*K)

ΔG(1300 K)=+378.5 kJ/mole, the reaction remains endergonic, unchanged even at 1300 K.

This last reaction demonstratively illustrates that not every equilibrium may be shifted to the other side with a temperature increase, sometimes everything remains as it was and the suggested reaction pathway must be discarded. This is the case for this reaction, in any case.

### 5. SUMMARY

The synthetic pathway described under Chapter 2 may be performed using the suggested reaction equations if the appropriate thermodynamic favorable temperatures are maintained, reaction (VI) representing the exception, because it may not occur at any of the calculated temperatures. Therefore, a clear synthetic pathway for preparing silicon nitride Si₃N₄ and silicon carbide SiC has been shown, which will be described once again supplemented with the required operating temperatures. Firstly, the oil sand is heated together with dichloromethane CH₂Cl₂ in an oxygen-free atmosphere to 1300 Kelvin (1000° C.). Silicon changes the binding partner and forms silicon tetrachloride according to equation (I):

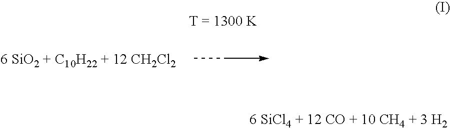

In a second step, the silicon chloride obtained is hydrogenated at room temperature with lithium Aluminum hydride (Hollemann, A. F. et al., Lehrbuch der Anorganischen Chemie [Textbook of Inorganic Chemistry], 91st-100th Edition, Walter de Gruyter-Verlag, Berlin, N.Y., pp. 743, 749 et seq. (1985)), according to equation (II).

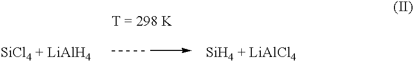

Finally, the monosilane SiH₄ obtained is combusted in pure nitrogen, equation (III), the ignition temperature having to be approximately 600 K above room temperature because of the activation energy required for breaking the nitrogen molecule:

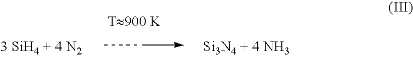

In order to obtain silicon carbide SiC, one starts again from silicon tetrachloride SiCl₄, which is obtained from equation (I), and reacts it with methane at 1300 K:

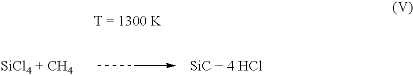

Instead of the monosilane obtained in equation (I), according to (Hollemann, A. F. et al., Lehrbuch der Anorganischen Chemie [Textbook of Inorganic Chemistry], 91st-100th Edition, Walter de Gruyter-Verlag, Berlin, N.Y., pp. 743, 749 et seq. (1985)), higher silyl chlorides may also be obtained via polymerization reactions of SiCl₂ and higher silanes may also be obtained by the following hydrogenation with LiAlH₄, as the following reaction equations indicate:

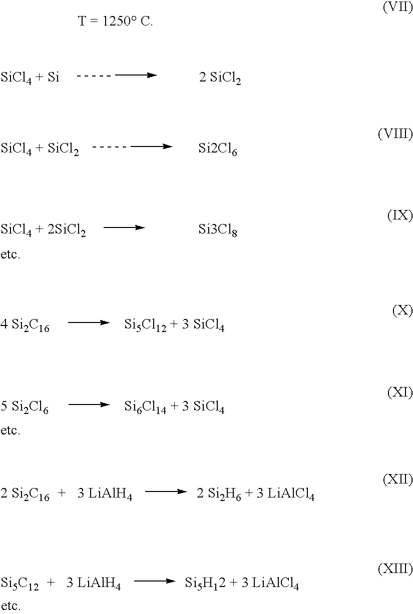

Higher silanes (from Si₇H₁₆) provide the advantage that they are no longer self-igniting and maybe combusted in a much more controlled way than SiH₄. Accordingly, combustion with pure nitrogen is also preferred if higher silanes reach this reaction.

### 6. BIBLIOGRAPHY

[1] Hollemann, A. F. et al., Lehrbuch der Anorganischen Chemie [Textbook of Inorganic Chemistry], 91st-100th Edition, Walter de Gruyter-Verlag, Berlin, N.Y., pp. 743, 749 et seq. (1985)
[2] Landolt-Börnstein, Zahlenwerte und Funktionen aus der Physik, Chemie, Astronomie, Geophysik und Technik [Numeric Values and Functions from Physics, Chemistry, Astronomy, Geophysics, and Technology], Volume II: Eigenschaften der Materie in ihren Aggregatzustanden [Properties of Materials in their Aggregate States], Part 4: Kalorische Zustandsgrössen [Caloric State Variables], 6th edition, Springer-Verlag.

What is claimed is:

1. A method for converting gaseous CO₂ into solid, nonvolatile products, the CO₂ being taken from an industrial (combustion) process or from the ambient air, having the following steps:
introducing a silicon dioxide compound which contains hydrocarbons (e.g., oil sand) into a combustion zone,
heating the combustion zone and igniting the hydrocarbon component using oxygen and/or using pyrolysis (e.g., in an induction furnace),
providing an oxygen-free combustion zone and blowing in gaseous nitrogen,
converting silicon dioxide from the silicon dioxide compound which contains hydrocarbons, using liquid or powdered Aluminum, or using halogen compounds, into silicon (Si2) and/or into silanes,
blowing in the gaseous CO₂,
coupling the carbon from the gaseous CO₂ to the silicon (Si2) and/or the silanes, in order to thus obtain silicon carbide as a solid, nonvolatile product.

2. The method according to claim 1, wherein water arises as a further product of atomic hydrogen of the silanes and the oxygen of the CO₂.

3. The method according to claim 1, wherein additional gaseous nitrogen is blown in, which radicalizes with the atomic oxygen of the silanes and is cleaved.

4. The method according to claim 3, wherein radicalized nitrogen forms silicon nitride (Si₃N₄) with the silicon from the silicon dioxide.

5. The method according to claim 4, wherein the reaction for preparing the silicon nitride (Si₃N₄) runs strongly exothermically and the waste heat thus arising is used for generating current.

6. The method according to claim 5, wherein the waste heat arising is used in a neighboring zone for melting Al₂O₃ (e.g., from bauxite).

7. The method according to claim 6, wherein pure Aluminum is produced in a cryolite-free electrolysis method.

8. The method according to claim 7, wherein current from the method cited in claim 5 is used.

9. The method according to claim 7, wherein the pure Aluminum is used in a loop for reducing the silicon dioxide in one of the method steps of claim 1 and is converted into pure Al₂O₃ at the same time.

10. The method according to claim 1, wherein the various endothermic and exothermic reactions of the various reaction partners are executed in a cascade.

11. The method according to claim 1, wherein one or more of the gaseous or powdered or liquid reaction partners is blown/introduced into the method using a spin (cyclone method), in order to set at least a part of the reaction partners present in the combustion zone into rotation.
